(19) United States
(12) Patent Application Publication
(10) Pub. No.: US 2004/0086602 A1
(43) Pub. Date: May 6, 2004

(54) Noodles having slits and method of producing the same

(76) Inventor: Michinobu Oka, Osaka-shi (JP)

Correspondence Address: ECKERT SEAMANS CHERIN & MELLOTT, 600 GRANT STREET, 44TH FLOOR, PITTSBURGH, PA, 15219

(21) Appl. No.: 10/688,455

(22) Filed: Oct. 17, 2003

(30) Foreign Application Priority Data
Oct. 18, 2002 (JP) 2002-303928

(51) Int. Cl. A21D 13/00

(52) U.S. Cl. 426/76

(57) ABSTRACT

A noodle has a plurality of slits formed at the central portion in the width of the noodle, and extending along the longitudinal direction of the noodle in a single line. At least one of the slits is closed at opposed ends thereof. When boiled, the noodles swell as a whole, and slits tend to be opened, so as to be easily caught by a fork or chopsticks. Once the noodles are caught and lifted up, they seldom escape. Compared to the conventional noodles, the noodles of the invention can be very easily picked up and be carried to the mouth.

### FIELD OF THE INVENTION

This invention relates to noodles that are easily caught by forks or chopsticks, and thus are easy to eat.

### DESCRIPTION OF THE RELATED ART

Persons who are visually impaired or who cannot skillfully use the chopsticks find it difficult to eat noodles such as “udon ” (wheat noodles) and ‘soba’ (buckwheat noodles) since they cannot skillfully pick up the noodles with chopsticks.

This invention is to provide noodles that are designed to be easily picked up even by persons who are visually impaired or who are handicapped in their hands.

### SUMMARY OF THE INVENTION

The present invention provides a noodle (1) having plural slits or incisions (2) cut along the longitudinal direction of the noodle (1) and arranged in a single line, at least one of the slits (2) being closed at opposed ends thereof.

When the noodles having slits are boiled, each of the noodles (1) swells and becomes bulky, whereby the slits (2) tend to be opened.

Since the noodles (1) are formed with slits (2) extending in the longitudinal direction of the noodles, a transfer of heat to the noodles is improved, whereby the noodles are boiled uniformly and quickly over the entire thereof.

The boiled noodles are put into a soup stock and are eaten as is, or are brought to a boil again in the stock and are eaten.

When boiled, at least one of the slits which is closed at its opposed ends becomes open at its central portion. Therefore, the noodles can be easily caught by the fork or the chopstick, at the time of eating. Once the noodles caught are lifted up, they seldom escape. In comparison with the conventional noodles having no slits, therefore, the noodles of the invention can be very easily picked up and can be carried to the mouth, even by persons who are handicapped in their eyes or hands

### BRIEF DESCRIPTION OF THE DRAWINGS

FIG. 1A is a front view of a noodle having slits before being boiled;

FIG. 1B is a perspective view of the noodle having slits after being boiled; and

FIG. 2 is a perspective view of an apparatus for producing noodles having slits from the noodle dough.

### DETAILED DESCRIPTION OF A PREFERRED EMBODIMENT

In the embodiment of the invention, wheat is used as the material of udon noodles. The invention, however, can also be realized by using other noodle materials such as buckwheat, spaghetti, etc.

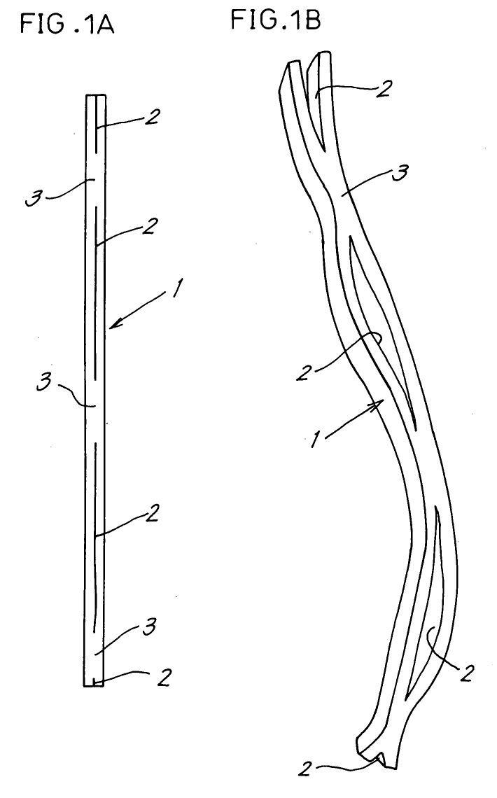

FIG. 1A illustrates a noodle (1) before being boiled, and FIG. 1B illustrates a noodle after being boiled (hereinafter simply referred to as “boiled noodle”).

When boiled, the noodle (1) of the embodiment swells to about 1.8 times the thickness and about 1.3 times the length of the raw noodle.

Numerical values relating to the size of the noodles described below are those before being boiled.

The noodles (1) can be produced in a desired thickness but are generally produced having a size of about 2-4 mm in thickness and about 2-4 mm in width.

Each noodle (1) has a plurality of slits (2) (2) arranged in a straight line. Each slit (2) is preferable to have a length of 3 to 8 cm.

When the length of the slit (2) is 8 cm or longer, the slit (2) forms too large annular portions when the noodles (1) are boiled, and are caught less easily by the chopsticks or the fork. When the length of the slit (2) is 3 cm or shorter, on the other hand, the slit (2) forms too small annular portions, and again are caught less easily by the chopsticks or the fork.

The portion (3) connecting the two adjacent slits (2) (2) in the longitudinal direction is preferable to have a length of 1-2 cm.

In case the connecting portion (3) between the slits (2) and (2) is not longer than 1 cm, it is liable to be torn during a boil of the noodle (1) or when the noodle (1) is picked up by the chopsticks or the fork. In this case, the adjacent slits (2) and (2) are brought into communication to each other resulting in that a lengthy slit is formed.

When the connecting portion (3) between the slits (2) and (2) has a length of 2 cm or longer, it becomes necessary to shorten the length of the slit (2) relative to the length of noodle (1) or to decrease the number of slits (2).

The length of the noodles (1) is preferable to be 10-30 cm.

Since people having visual impairment are unable to feel the length of the noodles lifted up by using the fork or the chopsticks, noodles hanging down from the mouth may stain the clothes. People having visual impairment tend to find it easy to eat the noodles with shorter length.

However, for the noodles (1) having a length shorter than 10 cm, the feeling to swallow is not satisfied.

The foregoing dimensions of length of the slit (2), the connecting portion (3) and the noodles are construed as being illustrative only. The noodles having the dimension outside those described in the above can be of course boiled and eaten.

There is a limitation on shortening the length of the noodles (1) for the following reasons.

In producing the noodles having slits, the noodle dough sheet is formed with slits, prior to being cut into a predetermined noodle width. However, when the long noodles are cut into a predetermined length, it is difficult for the long noodles to be automatically cut without getting into touch with slits (2).

The slits (2) are easily caught by the chopsticks or the fork but are hard to escape therefrom. Therefore, at least one of the plurality of slits (2) formed in a single noodle (1) has need to be closed at opposed ends thereof.

From the above two conditions, the length of the noodle (1) should be larger than the sum of the length twice that of the slit (2) and the length of the connecting portion(3) between the slits (2) and (2). Owing to this, the noodle including at least one slit which is closed at opposed ends thereof is produced, no matter where the noodle (1) is cut at any location in the longitudinal direction thereof.

[Steps of Producing the Noodles]

Described below are the steps of producing the noodles having slits.

A wheat powder and salt water are kneaded together to prepare a noodle dough which is, then, left to stand for several hours as is done customarily.

Next, the noodle dough is stomped by feet or other means having the same effect, producing a soft and glutinous property like rice-cake.

Then, the noodle dough is left to mature. Preferably, the noodle dough is left to stand overnight.

Next, the noodle dough is spread like a sheet to match the desired thickness of the noodles. It is desired that the noodle dough is gradually spread without applying an excessive force. The above-described steps are the same as those for producing ordinary noodles.

Slits or incisions (3) are formed in the sheet-like dough by using a slit cutter (5) which will be described later, prior to cutting off the sheet-like dough spread to a predetermined thickness to the desired noodle width.

The slitted noodles cut into a desired width are boiled. The boiling time is preferably 10 to 15 minutes. In the embodiment, the noodles were boiled for 12 minutes.

Through the boiling step, each of the noodles (1) swells, and the slits (2) tend to be bulged as seen in FIG. 1B. The open-ended slit becomes a V-shape.

The slits (2) are formed at the central portion in the width of the noodle, and extend along the longitudinal direction of the noodle in a single line. Therefore, a transfer of heat to the noodles (1) is improved, whereby the noodles are boiled uniformly and quickly over the entire thereof, hence decreasing the time required for boiling.

A specified amount of noodles are packed in a shallow box or are collected in bags, and are shipped.

The noodles of the present invention may be shipped without being boiled, and a person who has purchased the noodles may eat it upon boiling.

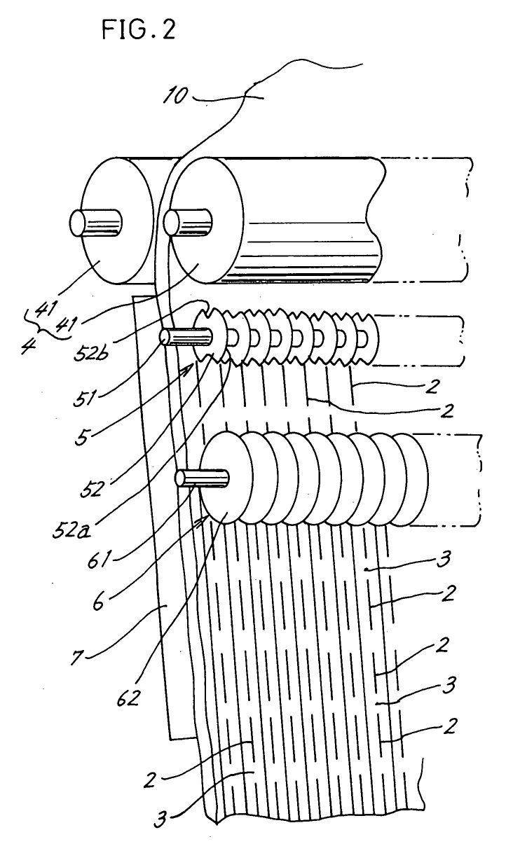

FIG. 2 illustrates an apparatus for making the slitted noodles from the noodle dough.

Spreading rollers (4), a slit cutter (5) and an individual noodle cutter (6) are arranged in this order from above to below, i.e., from the upstream side to the downstream side.

The spreading rollers (4) comprise a pair of rotatable rollers (41)(41). The noodle dough (10) as matured is held between the rollers (41)(41), spread to a belt-shaped form, and is fed downward.

The slit cutter (5) has a plurality of round blades (52) mounted on a rotary shaft (51) and arranged with a spacing corresponding to the width of the noodles, each round blade (52) being formed at the outer peripheral edge thereof with a notch (52b).

The circular-arc portion (52a) of the round blade (52) serves to cut into the noodle (1) to form slits (2), and the notch (52b) leaves the noodle dough as it is, to form a connecting portion (3) between adjacent slits (2) and (2), as shown in FIG. 1A.

In this embodiment, two notches (52b)(52b) are formed at the opposed positions on the circumference of the round blade (52). Two slits (2)2) and two connecting portions (3)(3)are formed per turn of the round blade (52).

The noodle cutter (6) has a plurality of round blades (62) mounted on a rotary shaft (61), with a spacing corresponding to the width of the noodle, each of the round blades (62) being positioned at the midway point between the round blades (52) and (52) of the slit cutter (5).

The sheet-like dough in which slits (2) are formed is cut into widths by the round blades (62)(62) of the noodle cutter (6).

On the back side of the sheet-like noodle dough, there is arranged a receiving plate (7) opposite to the slit cutter (5) and to the noodle cutter (6). The receiving plate (7) supports the noodle dough from the back side and prevents the noodle dough from escaping when the round blades (52) of the slit cutter (5) and the round blades (62) of the noodle cutter (6) are brought into contact with the noodle dough.

A cutter (not shown) is arranged downstream of the noodle cutter (6) to cut the slitted noodles into a predetermined length.

The noodles having slits can be efficiently produced from a mass of noodle dough, by using the above-described apparatus for producing noodles.

1. A noodle having slits formed along the longitudinal direction of the noodle and arranged in a single line, at least one of the slits being closed at opposed ends thereof.

2. The noodle as defined in claim 1 wherein the slit has a length of 3 to 8 cm, with an adjacent distance between the slits being 1 to 2 cm, and the noodle has an entire length of 10 to 30 cm.

3. A method of producing noodles comprising the steps of:
flattening a noodle dough to a sheet-like shape with spreading rollers;
forming slits in the flattened noodle dough so as to make plural lines of slits wherein the slits are formed along the transfer direction of the noodle dough, the lines being spaced at even intervals in the transverse direction and the slits of each line being spaced at even intervals in the transfer direction; and
cutting off the noodle dough at positions between the adjacent lines of the slits, in the said transfer direction of the dough.
